(19) United States
(12) Patent Application Publication
(10) Pub. No.: US 2026/0004566 A1
(43) Pub. Date: Jan. 1, 2026

(54) METHOD AND SYSTEM FOR MONITORING THE ROAD CONDITION BY MEANS OF A MACHINE LEARNING SYSTEM, AND METHOD FOR TRAINING THE MACHINE LEARNING SYSTEM

(71) Applicant: Continental Autonomous Mobility Germany GmbH, Ingolstadt (DE)

(72) Inventors: Sighard Schräbler, Karben (DE); Niels Christmann, Frankfurt am Main (DE); Pia Dreiseitel, Eschborn (DE); Erwin Kraft, Frankfurt am Main (DE); Bernd Hartmann, Bad Homburg (DE); Florian Geis, Geisenheim (DE)

(73) Assignee: Continental Autonomous Mobility Germany GmbH, Ingolstadt (DE)

(21) Appl. No.: 18/879,910

(22) PCT Filed: Jun. 6, 2023
(86) PCT No.: PCT/DE2023/200113

§ 371 Date: Dec. 30, 2024

(30) Foreign Application Priority Data
Jun. 29, 2022 (DE) 10 2022 206 625.1

(51) Int. Cl. G06V 10/774; G01J 5/10; G01N 21/55; G06V 10/26; G06V 10/82; G06V 10/94; G06V 20/56

(52) U.S. Cl. CPC G06V 10/7747; G06V 10/26; G06V 10/82; G06V 10/95; G06V 20/588; G01J 5/10; G01N 21/55

(57) ABSTRACT

The present disclosure relates to a method and system for monitoring the road condition by a machine learning system and to a method for training the machine learning system. The methods include: providing or acquiring data by a sensor system of a vehicle, wherein the sensor system captures the surroundings of the vehicle (2) as training input data X; providing or acquiring data which characterize the road condition by means of a reference sensor fitted in or on the vehicle as training target values, and training the machine learning system. Training data, which include training input data X and training target values corresponding to these training input data X, are provided. The training data are used to adjust parameters of the machine learning system in such a manner that the machine learning system generates output data similar to the training target values when the training input data are input.

### CROSS-REFERENCE TO RELATED APPLICATIONS

The present application is a National Stage Application under 35 U.S.C. § 371 of International Patent Application No. PCT/DE2023/200113 filed on Jun. 6, 2023, and claims priority from German Patent Application No. 10 2022 206 625.1 filed on Jun. 29, 2022, the disclosures of which are herein incorporated by reference in their entireties.

### TECHNICAL FIELD

The present invention relates to the road condition monitoring (road condition observation) or roadway condition recognition from a driving vehicle which has sensors for capturing its surroundings. This topic is of immense importance for avoiding accidents since certain roadway conditions or surfaces reduce the static friction or the friction coefficient between tires and the roadway surface. This increases stopping distances, or braking maneuvers lead to skidding and swerving of the vehicle, which can lead to serious accidents. In the case of automated steering and/or braking interventions during assisted or autonomous driving (ADAS/AD system), the system therefore has to be able to also appraise the road condition as realistically as possible before the vehicle drives over it. Since this is not yet possible with sufficient reliability, driving tests for autonomous vehicles frequently take place in sunny areas where snow and ice are not to be expected.

In order to better recognize road conditions, the aim is to utilize machine learning in an innovative setup. In particular, the present invention relates to a method for training a machine learning system for monitoring the road condition, a method for monitoring the road condition using a trained machine learning system, a system for monitoring the road condition as well as a vehicle having a system for monitoring the road condition.

### BACKGROUND

The YouTube video of a road condition segmentation, on the basis of video data from a camera and driving noises which are captured in the process by a microphone, for one and the same road, is known. A distinction can be made between dry and wet:
Road condition estimator using cameras and microphones (2018)
https://www.youtube.com/watch?v=H13jgv5508w (accessed on 25 May 2022).

The differentiation into more than two classes (wet/dry) is difficult or not possible in a reliable manner with this approach.

WO 2016/177372 A1 discloses a method for recognizing and evaluating environmental influences and roadway condition information in the periphery of a vehicle. At least two digital images are generated in a successive manner using a camera, and the same image section is selected on each image. Alterations in the image sharpness between the image sections of the at least two successive images are recognized using digital image processing algorithms, wherein the image sharpness alterations are weighted in a decreasing manner from the center of the image sections towards the outside. Environmental condition information is established as a function of the recognized image sharpness alterations between the image sections of the at least two successive images with the aid of machine learning methods, and roadway condition information is determined as a function of the established environmental condition information.

WO 2019/174682 A1 discloses a method for classifying a roadway condition on the basis of image data from a vehicle camera system and a corresponding vehicle camera system. The method has the following steps of:
providing image data by means of a vehicle camera system which is configured to depict at least one section of the surroundings outside of the vehicle, wherein the section at least partially contains the roadway on which the vehicle is driving;
differentiating diffuse reflection and specular reflection of the roadway by evaluating differences in the appearances of at least one point of the roadway in at least two images of the camera system, wherein the images have been acquired from different acquisition perspectives;
establishing whether, in at least one image of the camera system, there are disturbances which have been caused by at least one wheel of a vehicle whirling up a substance covering a roadway as the wheel travels thereover;
classifying the roadway condition into one of the five following roadway condition classes, taking account of the results with regard to the reflection type and the disturbance intensity:
a) dry roadway: diffuse reflection type without disturbance
b) normally wet roadway: specular reflection type with disturbance
c) very wet roadway with risk of aquaplaning: specular reflection type with much disturbance
d) snowy roadway: diffuse reflection type with disturbance, or
e) icy roadway (black ice): specular reflection type without disturbance.

Known problems with camera systems are, for example, that the signal-to-noise ratio is low in the dark; on the other hand, if the signal-to-noise ratio is improved through longer exposure, motion blur is incurred when the camera system moves.

DE 102013002333 A1 discloses a method for predictively determining the condition of the road in a vehicle, in which a road surface is illuminated with sensor beams, wherein the sensor beams are reflected and absorbed in accordance with a condition of the road surface, and wherein the condition of the road is determined based on the reflected sensor beams. The method is characterized in that the road surface in front of the vehicle in the direction of travel is illuminated. Since the different conditions of the road surface have different optical properties and correspondingly act in an absorbing manner for certain wavelengths and in a reflecting manner for others, the respective condition of the illuminated road surface can be inferred from the reflected sensor beams. An example of this is, for instance, the wavelength 1550 nm which is absorbed by ice to a comparatively significant degree.

DE 102014214243 A1 discloses a method for determining the road condition, wherein road condition data from a weather map and/or road map are enlisted for determining the road condition, wherein the road condition data from the weather map and/or road map are subjected to a re-digitization.

DE 102017223510 A1 discloses an optical sensor for assessing surfaces, having:
at least one emission unit for outputting a modulated optical signal onto a surface to be assessed;
at least one detection unit for capturing an optical signal of the modulated signal reflected at the surface and providing an electrical output signal dependent on the reflected optical signal; and
a control device for analyzing the output signal of the at least one detection unit and establishing a condition of the surface to be assessed, wherein a frequency spectrum of the modulated optical signal which can be sent out by the at least one emission unit is substantially delimited with respect to a frequency spectrum of an interference spectrum.

All of the known methods have disadvantages and do not completely solve the relevant difficulties. In particular, what is interesting is a predictive and reliable recognition of “black ice,” i.e., a frozen-over black road (covered with ice) which is difficult to see even for humans.

### SUMMARY

It is therefore an object of the present disclosure to provide a method which makes it possible to predictively recognize the roadway condition in an affordable manner, without compromising on the robustness of the recognition of types of roadway condition which are relevant to safety.

This object is addressed by the subject-matter of the independent claims. Further developments of the present disclosure are set out by the subclaims and the following description.

One starting point is to use surroundings-capturing sensors which are already installed in a vehicle for other tasks and, first and foremost, to capture regions in front of the vehicle in the direction of travel.

The shortcomings of the existing surroundings-capturing sensors can be compensated for by specialized reference sensors which are therefore, for the most part, too expensive for series deployment in that the reference sensors likewise contribute to the determination of the road condition during the generation of training data for a machine learning system. To generate training data, test vehicle fleets having the surroundings-capturing sensors are frequently utilized for subsequent series deployment. The captured data are then, as a general rule, labeled manually in order to provide the actual road condition for the training of the machine learning system. The manual labeling is carried out by humans, wherein the human perception of road conditions is subjective. For example, when is a “wet roadway” present? Is an older layer of ice present beneath a visible layer of fresh snow? Is black ice present on a black road or is it a dry black road? Moreover, manual labeling is both time-consuming and costly.

A second starting point is to utilize an explicit road condition determination sensor which is extremely reliable and precise as the reference sensor. In this case, it is favorable if the (“pure”) road condition determination sensor can predictively determine whether there is water on the road surface and what the temperature is on the road surface. A transmitting and receiving device which works in the wavelength ranges of 1550 nm and approximately 2 to 10 micrometers can determine both of these facts.

One aspect of the present disclosure relates to a method for training a machine learning system for monitoring the road condition, including the steps of:
providing or acquiring data by means of a sensor system of a vehicle, wherein the sensor system captures the surroundings of the vehicle as training input data;
providing or acquiring data which characterize the road condition by means of a reference sensor fitted in or on the vehicle as training target values; and
training the machine learning system;
   wherein training data, which include training input data and training target values corresponding to these training input data, are provided, and
   the training data are used to adjust parameters of the machine learning system in such a manner that the machine learning system generates output data similar to the training target values when the training input data are input.

The data of the sensor system (sensor data) can include, for example, image data, radar data and/or lidar data.

The training data are used to train the machine learning system, i.e., to adjust parameters of the machine learning system in such a manner that the machine learning system generates output data similar to the training target values when the training input data are input. In the case of neural networks, for example, the parameters include the weightings between individual input values and neurons. A supervised learning method is used to train the machine learning system, wherein a plurality of learning methods is known. Thus, the backpropagation method can be used to train a neural network, for example. During the course of the training, the parameters of the machine learning system are adjusted in such a manner that an error between the output data and the training target values becomes as small as possible. The error between the output data and the training target values is determined, for example, via the distance between the output data and the training target values, and a corresponding metric for output data. In this case, it should be noted that an overfitting is avoided, which is achieved, for example, by considering the error between output data generated from test input data and the associated test target values. The test target values are assigned to the test input data and the test input data and test target values are not used for adjusting the parameters of the machine learning system.

Optionally, the parameters of the machine system can be output when the training has been successfully concluded, e.g., because the output data are sufficiently similar to the training target values, which can be specified, e.g., via a threshold value of a similarity metric.

In one embodiment, the sensor system includes a camera system of the vehicle so that the provided or acquired data are image data and the image data serve as training input data. The reference sensor determines reference data as training target values for image data (labels).

The camera system can, for example, be a monocular camera arranged in a vehicle, such as behind the windshield, so that the area in front of the vehicle can be captured in accordance with a visual perception of a driver of the vehicle. Alternatively, the camera system can be a stereo camera which provides depth information regarding the vehicle's surroundings or a satellite camera system, e.g., a surround-view camera system which includes multiple fisheye cameras looking in different directions of the vehicle.

Thanks to the downstream processing of the image data and the reference sensor data by means of the machine learning system (“AI camera”), the capabilities of the reference sensor for monitoring the road condition can be transferred to the camera system with corresponding learning methods.

According to one exemplary embodiment, the reference sensor includes a transmitting and receiving unit which emits electromagnetic radiation of at least one defined wavelength onto the road and receives and measures the intensity reflected by the road, and wherein the reference sensor is adapted to indicate probabilities for the presence of various classes of road conditions on the basis of the measured values. The presence of water on the road can be carried out by means of the measurement of the absorption at discrete wavelengths in the mid-infrared. A comparison of the measurement results of two suitable wavelengths (ratiometric measurement) makes it possible to recognize water on the road in a robust manner.

A suitable reference sensor for displaying ground truth data can recognize all target learning classes of the camera system independently of the light distribution (brightness) which depends on the time of day.

This is the prerequisite for the learning result of a camera system (as a sensor system) being able to be optimally adjusted to the very different light distribution (brightness) at the time of day by controlling the exposure of the cameras.

As a result, it can be guaranteed that it is largely possible to recognize the roadway condition via the camera system not only in daylight, but also at dusk and at night, provided that a camera is sufficiently sensitive.

Advantageously, the wavelength ranges of the observation between the reference sensor and the camera system do not match. The camera observes in visible light and the reference sensor observes, for example, in the infrared range.

In one embodiment, it is provided that motion blur in the image caused by different driving speeds and by the set exposure time is also learned. The two parameters can flow both into classes and, based on a linear approximation, into the learning result.

The speed over the ground can advantageously be a useful additional input variable.

According to one exemplary embodiment, it is provided that weather and driving dynamics data such as ABS, ASR and/or ESC control interventions of the ego vehicle can be advantageously incorporated into the learning result. In that case, this can be referred to as early fusion of the labeling sizes.

It is moreover or alternatively provided, according to one embodiment, that for manually driven vehicles, in addition to the driving speed already mentioned, the driving style based on vehicle accelerations in the longitudinal and transverse directions or, alternatively, the safety distance from vehicles driving ahead is also taken into account.

In one embodiment, the reference sensor outputs probabilities for the presence of (at least) the following classes of road conditions: “dry,” “wet,” “snow,” “ice” and “unknown/error.” An error in the case of a camera sensor as the sensor system is, e.g., a predominantly black or white image or predominant image noise due to underexposure.

According to one exemplary embodiment, the reference sensor includes a pyrometer which measures the temperature of the road. For example, the reference sensor can measure in the thermal (far) infrared, e.g., in the range from 2 to 10 μm, in order to derive the surface temperature from the thermal radiation. By contrast, thermal features in the far IR, e.g., are invisible in the visible spectrum, which is why humans already have very great difficulties recognizing black ice.

In one embodiment, the reference sensor utilizes the following wavelengths: 1550 nm and 980 nm in order to detect the presence of water by a comparison of the reflected intensities, and a wavelength in the range of 2 to 10 μm in order to measure the temperature of the road.

In one exemplary embodiment, the machine learning system is a neural network. Neural networks are particularly well-suited to the described method since they can be easily adjusted.

The neural network is in particular a convolutional neural network. The nonlinearity of the convolutional neural network does not pose a problem for the usability of the described method.

The described method can, however, also be used with other machine learning systems, for example with decision tree learning, with support vector machines, regression analysis or Bayesian networks. Furthermore, it is possible to use the described method in a multi-task classification system. The multi-task classification system includes, for example, an encoder and a plurality of decoders. It is further possible to divide the machine learning system into multiple subsystems. Each of the subsystems has the functionality of the machine learning system described here, although the subsystems do differ from one another, for example in the type of machine learning system or in the selection of the training data. Output data generated using the subsystems can then be combined in order to obtain an improved output.

According to one embodiment, the vehicle includes a data transmission unit, and the data transmission unit is adapted to transfer training data to a server unit (backbone). This makes it possible to construct a data-driven ecosystem (DDE) for the development of machine learning systems, e.g., for determining road conditions based on sensor data from standard surroundings-capturing sensors.

In one exemplary embodiment, the server unit is adapted to update a training data set including a (specified) quantity of training data, wherein the size of the training data set is kept constant, and wherein it is ensured, based on one or more quality criteria (e.g., the quality can be evaluated based on multiple KPIs), that the relevance of the training data in terms of the road condition determination is increased when the training data set is updated.

According to one exemplary embodiment, in order to achieve a high degree of reliability even in the case of unknown scenarios, the training takes place in a DDE with continuous improvement of the data relevance. In the backend of the DDE, automatic methods according to key performance indicators (DAgger) and, with considerably reduced effort, human judgement (active learning) as well are utilized.

The DDE is embodied such that the size of the data set is kept constant after a limit is reached. As a result, the training times for the machine learning system do not increase any further. The computing power in the backend is utilized to increase the relevance of the training data set.

According to one embodiment, the server unit is adapted to attain a balance of the training data set during the updating, so that the training data set has a high degree of diversity, wherein rarer road conditions are sufficiently represented by training data. Rare situations such as, e.g., black ice, i.e., a frozen-over black road, are encountered particularly rarely, but are also particularly dangerous since the coefficient of friction is greatly reduced.

In one exemplary embodiment, the relevance of the training data set is evaluated in such a manner that a high degree of relevance is attributed to the training data which are orthogonal to the other training data already contained in the training data set.

According to one embodiment, the sensor data for the captured region of the road are divided into segments and the data provided or acquired by the reference sensor characterize the road condition for the segments.

The high spatial resolution makes it possible to segment the sensor data on the road ahead, such as with the aid of the recognition rules condensed in the network and, as a result, even makes possible a predictive and spatially resolved measurement. Reaction time is gained and, at the same time, the costs of the application are lowered by up to two orders of magnitude compared to the reference measurement technology.

A further aspect relates to a method for monitoring the road condition utilizing a machine learning system, wherein the machine learning system has been trained as described above, wherein data captured by a vehicle sensor system, which captures the surroundings of the vehicle, are provided to the machine learning system as input data, and the machine learning system generates output data which characterize the road condition from the input data.

A third aspect relates to a road condition monitoring system including an input unit for receiving input data; a computer unit which is designed to carry out the previously described method for monitoring the road condition; and an output unit for outputting the output data generated by the computer unit.

A further aspect relates to a vehicle including a sensor system, wherein the sensor system is adapted to capture the surroundings of the vehicle and to provide the captured sensor data to the input unit as input data, as well as a previously described road condition monitoring system.

The following problems can arise when constructing a training data set (e.g., in a server unit):
a) A great deal of similar data is generated
b) There are rare classes
c) The classes are very strongly correlated with the test locations. Thus, more ice is detected in Sweden, more wetness in Germany, more dryness in southern Spain. Thanks to the correlation with the location, the location could be incorrectly learned instead of the road condition.
d) Nevertheless, rare classes are relevant. The rare classes are practically neglected, but it is precisely these which are the particularly dangerous cases.
e) The wavelength ranges of the observation between the reference sensor and the camera do not match; the reference sensor observes, e.g., at discrete wavelengths in the mid-infrared, in order to detect absorption of water and ice and in the thermal (far) infrared, in order to derive the surface temperature from the thermal radiation. The camera observes light in the visible wavelength range. Thermal features in the far IR are, e.g., invisible in the visible spectrum, which is why humans already have very great difficulties recognizing black ice. Instead, they derive the condition from observing the surroundings and other optical features. I.e., it is in principle possible to differentiate the road condition into four to five classes using camera optics, but it is difficult. You would have to learn from an enormous number of examples and, therefore, purely camera-optical road condition recognition has not necessarily been sufficiently robust to date.

A data-driven ecosystem offers the following solutions in order to address such problems.
1) Policy aggregation: If you learn a random decision forest, you do not take one decision tree, but rather a whole “bag full of them,” that is to say, a “bag of classifiers method.” This makes a majority decision possible and, as the progress in learning increases, variants of existing, successful decision trees are randomly formed and added, while unsuccessful ones are discarded. At the end, you arrive at a very good result by way of a majority decision from many good classifiers. The method can be easily applied if the individual classifier is calculated sparingly. This is so in the case of decision trees with few yes-no criteria. It is an evolutionary method, no gradients are calculated, no backpropagation.
2) Backpropagation: With backpropagation, modern neural networks learn from the difference between the desired output and the random output attained after initial initialization. Using the chain rule, the differences (gradients) are translated back into the layers of the network and, as a result, it is determined how the weights and offsets in the network have to change in order to arrive at a better solution. In backpropagation, the repeated application of redundant data is disruptive because irrelevance is introduced therewith. Specific, possibly very similar cases are over-learned, indeed virtually meticulously memorized, but slightly different test data are not recognized as well as the training data, so-called overfitting.
3) Splitting the data: On the recognition side, a split into training and test data helps against overfitting, wherein a KPI (Key Performance Indicator) which is to be measured, e.g., the precision or accuracy of the output for the test data, must be at least as good as for the training data. It does not help if the training data are too close to the test data, because they are, e.g., adjacent images of the same sequence. This must be avoided.
4) Batch normalization: Neurons in the networks function on the simplistic assumption that a linear coupling with the next layer is sufficient because the input data, the output data, but also the data in the intermediate layers are offset-free and equally distributed. This can be achieved by a layer-by-layer renormalization (loffe and Szegedy, Google)
5) Dropout: Clumps of neurons without function can form in the network during the learning process. The objective is that every partial region in the network contributes equally to the classification. A particular difficulty is the problem of disappearing and exploding gradients. I.e., when carrying back with the aid of the chain rule, the requirement of the neurons to reduce their weightings becomes exponentially smaller or exponentially larger in layers. In order to avoid this, approximately 50% of the neurons are randomly selected and deactivated in each learning step. The strength of the signal is adjusted for the remaining 50% and only this 50% is trained in the current step. In the next iterative training step, another 50% of neurons are chosen so that each subset of the network is forced to carry the same functionality, the full network is then simply more powerful only according to its size, but there are hardly any neurons which remain unconnected because the associated weights remain close to zero.
6) Regularization: This is a method which is perhaps best compared to measuring depth in a crater. The deepest point corresponds to the best solution, but the crater is not just in the shape of a bowl, but again has mountains and further craters therein. It is actually a whole crater field of overlapping craters. During a simple search for the deepest point, in the example a ball which is thrown into the field, there is a risk that the ball will get stuck in a local minimum, i.e., the best solution will not be determined, but rather only the next best one locally. Regularization means that adhering powder is filled into the crater landscape. This fills the smaller craters, at least following solidification, so that there remain fewer chances of getting stuck in a local minimum. Regularization must be utilized very sparingly. Figuratively speaking, the crater landscape should not be allowed to be filled in up to the top and therefore level out all the differences. However, when utilized in small doses in the per mil range, regularization has the effect of eliminating special recognition features and instead finding more generally valid, basic rules, admittedly at the price of an “apparently” reduced accuracy. That is to say that a simple KPI comes out worse, even though the classification is actually better.
7) Activations: Activations can be calculated with a type of visual backpropagation on the GPU in parallel to the actual neural network. For the convoluted layers (not for the fully connected layers), they indicate which neurons are involved in the decision and project this back onto the input layer of the network. I.e., as a human, you can judge which features were enlisted to make the classification decision if the activations are overlaid with the corresponding input image. This helps to understand what is going wrong if something has been incorrectly detected and provides valuable information about possible missing training examples. It also provides a clear indication in addition to simply observing the KPIs.
8) Key performance indicators or KPIs for short: A simple two-class detector can either respond, not respond, report correctly or report incorrectly—that is to say, four cases here in all combinations. If detected, recall is high. It is conceivable that a scene is darkened further and further until the image is black. If the output were an image again, not just a class, it would be possible to count pixels which depict a known feature and which are recognized. In addition, other pixels which do not belong to the known feature could also respond. These would then be false positives. That is to say that it is a question of two different things: about recognition and about the correctness of the result. This can either be plotted in a diagram or summarized in the F2 score. Simply, a KPI is a previously defined measure which indicates, on average, how well a network is trained across the test data set.
9) Data aggregation: This is very similar to policy aggregation. Instead of, e.g., calculating 500 neural networks and calibrating the majority of their output, the problem is shifted from the time of execution to the training time and therefore to the selection of the relevant data. As a result, only one network has to be calculated, but the starting point is a subset of the training data, e.g., 5% thereof, and the next 5% contingent is looked at to see which images are already classified correctly with the training of the first 5%. They are simply not needed. The process is similar to preparing for an examination where it is necessary to learn what has not yet been understood. Data aggregation is when the machine decides which data are relevant; these are the data which have already been learned orthogonally to all the other data.
10) Active learning: The situation sometimes occurs that data are labeled incorrectly. The network notices this during the data aggregation; it cannot be that an image is to be output dry and wet at the same time. This suggests that one image is wrong. But which one? In these cases, the human has to decide, but because the process is so automated, only the controversial cases have to be decided on.
11) Constant size of the data set: No constant increase in the learning time. The DDE then decides again independently whether the data are relevant. When the data set has finally arrived at its target size, data aggregation can attempt to exchange new data for old data, which are classified as relevant. The quality is continually measured based on multiple KPIs. If the new solution in the form of a newly learned neural network is below average, then it is rejected; if it is above average, it is favored.
12) The data-driven ecosystem: In its backend, that is to say the function which is subsequently calculated in the cloud, it is a constant challenge to the best networks calculated up to that point whether they are better than before by exchanging them for more relevant training data following training. This essentially depends on the test data set which has to be adjusted exactly like the training data set. It should contain the relevant cases in all surroundings situations as well as the rare cases and the corner cases.
13) Synthetic data (derived from real data): By definition, rare cases are uncommon. To ensure that they are not underrepresented, synthetic data can be derived from regular data using GAN style transfer, i.e., the synthetic data answer the question of what a landscape looks like in a different weather condition or what a weather condition looks like in a different location. That is to say that, since a great many images can be taken of locations but only a few of rare conditions, the condition will be transferred to another location.
14) Speed-dependent, time-offset evaluation: What is visible on the front camera is further ahead on the road than the current measurement spot. To be on the safe side, a time shift must be conducted in which the path of the measurement spot on the road is brought into line with the image of the road. Conversely, a segmentation can also be calculated instead of a categorical classification. If a network which recognizes the location of the road in the image is additionally deployed, the road with the road condition can be learned in a segmented manner and consequently displayed.
15) Average values say more than individual values: On the inference side, that is to say in the application of the network, opportunities also arise for improvement and for catching outliers through averaging. Thus, e.g., changes in the entire weather situation are not to be expected every second; the road condition is a phenomenon which can, admittedly, very likely change at spatial boundaries, whether it is when driving off the factory floor or out of a tunnel or when crossing a bridge. Particularly significant changes can be expected here. If it is possible to successfully recognize this, the result can be stabilized in all other cases by averaging.
16) Testing the networks in synthetic scenes and in driving tests: In order to cover standard cases and known rare cases & corner cases, an additional test to the normal training data to check the plausibility of the behavior. A test course has to be overcome.
17) Securing of the transfer: In the simplest case, an update is carried out via a USB stick. However, an update function for the vehicle fleet following delivery and over the lifetime of the product is also expedient. To avoid transfer errors and manipulations in a complete DDE, checksums and a cryptographic signature as well as encryption are added to the actual data.
18) Update: For fleet application, the data should, for example, be transferred over the air (OTA). It is assumed that vehicles will in future be equipped with a SIM card and will be able to establish a tunneled internet connection to the update server. Of course, a conventional update is also always possible, e.g., via a USB stick and file system.
19) Triggering of interesting data: It is known from the Tesla patent in particular that rare cases and corner cases, that is to say, in our case rare road weather situations, are to be acquired. At Tesla, the trigger itself is also a network again, which has been trained to respond to certain scenarios. This very same technology would also be applied here in order to improve the product in a data-driven manner in a second, continual circuit. Triggering is also conceivable in only a few measuring vehicles which are equipped with reference sensor technology. However, the greater benefit due to the larger number of use cases is clearly a trigger in each vehicle in the fleet, because this is the only way the system scales itself.
20) Feedback channel: over the air (OTA), however also conventionally in the workshop via USB or other bus systems. An OTA update channel for the vehicle offers the advantage that the vehicle manufacturer does not have to initiate a product recall if software updates are necessary. Moreover, a feedback channel helps to continually improve products. Moments which are triggered and otherwise selected, e.g., by test drivers or drivers, and measurements assigned to them are reported back. Data volumes of up to multiple 100 MB for various sensors per manufacturer are a realistic order of magnitude. I.e., there is much more data available than has to subsequently be trained into the corresponding sensor networks. A good methodology for selecting the training data and for evaluating the networks to be trained using KPIs is all the more important.
21) Virtualization of the ecosystem, connections and sourcing: All of this happens in the backend, such as in the cloud. The entire backend can be virtualized, i.e., moved to a docker container and operated on a large cloud instance with sufficient performance. The advantage of this is that the post-processing can also be scaled with the size of the fleet. That is to say that there is a data connection between the fleet, provider and cloud provider. This is, in turn, independent of the location where the data are curated and new algorithms are integrated. Access to the cloud should be possible worldwide without any problems, as should rolling out the data.
22) Design anonymization and data protection without adverse effects: Due to locally prevailing data protection regulations, source anonymization should be considered. This is because if no personal data are stored, then no laws can be violated either in the concept of globally available cloud processing and data curation. It should be ensured that the anonymization does not have any unwanted impact on the main function. However, in the case of road condition observation, an anonymized face and an anonymized license plate should not pose a problem except, perhaps, the license plate would be very large in the image and would, e.g., be relabeled from a dark background to a light background. Extreme white tones in the image can be an indicator of snow, which would then, e.g., be incorrectly classified as more likely. Exactly the same adverse effects are to be tested and methodically avoided (e.g., making them unrecognizable only with a background color).

### Adjustment of the Driving Behavior to the Road Condition:

The objective of all these efforts in the case of road condition measurement is simply appropriate driving behavior. The driver would definitely not want to be informed about the condition every second; he/she is certainly expert enough for that. Warnings would be given in the event of slippery conditions, that is to say a greatly reduced coefficient of friction. The actual coefficient of friction can only be estimated since it depends on the road and tires. The main application of the road condition measurement is highly automated driving, since the travel planning must also be informed about the road condition. It might be necessary to drive more slowly, and understeer and longer stopping distances might have to be expected. What is a given for us humans has to be made understandable to the machine with a technical method. It is an advantage if the technical method is cost-effective.

The purpose of road condition monitoring lies in the field of warning drivers in the event of slippery conditions (in particular, black ice) but even more in the field of highly automated driving. Here, the assumptions regarding the stopping distance have to be constantly updated according to the road weather, as a result of which the driving behavior adjusts to the weather conditions.

Average values say more than individual values: On the inference side, that is to say in the application of the network, opportunities also arise for improvement and for catching outliers through averaging. Thus, e.g., changes in the entire weather situation are not to be expected every second; the road condition is a phenomenon which can, admittedly, very likely change at spatial boundaries, whether it is when driving off the factory floor or out of a tunnel or when crossing a bridge. Particularly significant changes can be expected here. If it is possible to successfully recognize this, the result can be stabilized in all other cases by averaging.

Speed-dependent, time-offset evaluation: What is visible on the front camera is further ahead on the road than the current measurement spot. To be on the safe side, a time shift must be conducted in which the path of the measurement spot on the road is brought into line with the image of the road. Conversely, a segmentation can also be calculated instead of a categorical classification. If a network which recognizes the location of the road in the image is additionally deployed, the road with the road condition can be learned in a segmented manner and consequently displayed.

### BRIEF DESCRIPTION OF THE FIGURES

Exemplary embodiments of the present disclosure are explained in greater detail below with reference to drawings, wherein:

FIG. 1 shows a vehicle having a surroundings-capturing sensor system, a reference sensor and a processing unit;

FIG. 2 shows an illustration of a machine learning system which is trained to generate output data which characterize road conditions based on data from the surroundings-capturing sensor and the reference sensor;

FIG. 3 shows a trained machine learning system which can generate output data which characterize the road condition based on data from the surroundings-capturing sensor;

FIG. 4 shows a road condition monitoring system; and

FIG. 5 shows a vehicle having a reference sensor with a transmitting and receiving unit.

### DETAILED DESCRIPTION

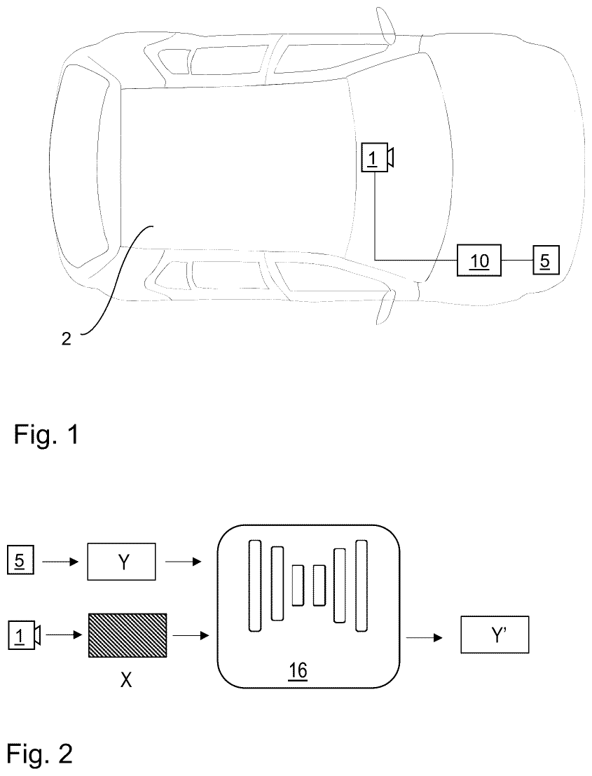

FIG. 1 schematically shows a top view of a vehicle 2. The vehicle 2 has a surroundings-capturing sensor system 1, a reference sensor 5 and a processing unit 10. The surroundings-capturing sensor system 1 can be or include, e.g., an image acquisition device. The image acquisition device can be a front camera of a vehicle. The front camera can be arranged inside the vehicle 2—for instance, in the region of the rear-view mirror—and capture the surroundings in front of the vehicle 2 through the windshield of the vehicle 2. On the basis of the signals or image data from the front camera, details of the surroundings of the vehicle 2 can be detected, e.g., objects. On the basis of the surroundings detection, ADAS or AD functions can be provided by an ADAS/AD control unit, e.g., lane recognition, lane keeping support, traffic sign recognition, speed limit assistance, road user recognition, collision warning, emergency braking assistance, adaptive cruise control (ACC), roadwork assistance, a highway pilot, a Cruising Chauffeur function and/or an autopilot.

The image acquisition device typically includes optics or a lens and an image acquisition sensor, e.g., a CMOS sensor.

In this case, the proposed surroundings-capturing sensor system 1 considers a sensor setup for vehicles in the context of assisted and autonomous driving. This can optionally be extended to a multi-sensor setup. The advantage of multi-sensor systems is that they increase the safety of detection algorithms for road traffic by verifying the detections of multiple sensors. In this case, multi-sensor systems can be any combination of:
one to multiple cameras,
one to multiple radars,
one to multiple ultrasonic systems,
one to multiple lidars, and/or
one to multiple microphones.

It is advisable to utilize an explicit road condition determination sensor which is extremely reliable and precise as the reference sensor 5. In this case, it is favorable if the road condition determination sensor can predictively determine whether there is water on the road surface and, optionally, also what the temperature is on the road surface.

A transmitting and receiving unit which emits electromagnetic radiation of at least one defined wavelength onto the road and receives and measures the intensity reflected by the road is ideal for this purpose. The reference sensor is adapted to indicate probabilities for the presence of various classes of road conditions on the basis of the measured values. The presence of water on the road can be carried out by means of the measurement of the absorption at discrete wavelengths in the mid-infrared. A comparison of the measurement results of two suitable wavelengths (ratiometric measurement) make it possible to recognize water on the road in a robust manner. For example, the reference sensor can utilize the following wavelengths: 1550 nm and 980 nm in order to detect the presence of water by a comparison of the reflected intensities.

A transmitting and receiving device which works in the wavelength range of approximately 2 to 10 micrometers can determine the temperature on the road surface. Alternatively, in order to measure the temperature, another pyrometer which can measure a temperature of a surface at a defined distance can be used.

The vehicle 2 having the reference sensor 5 and the surroundings-capturing sensor system 1 is a test vehicle for generating training data. A corresponding vehicle having the surroundings-capturing sensor system 1 and a trained machine learning system 16 can be utilized as a series vehicle without the cost-intensive reference sensor 5.

FIG. 2 shows an illustration of a machine learning system 16 which is trained based on data X of the surroundings-capturing sensor system 1 and corresponding data Y of the reference sensor 5 to generate output data Y′ which characterize the road condition.

An artificial neural network can serve as the machine learning system 16. Neural networks are particularly well-suited to the described method since they can be easily adjusted.

The neural network is in particular a convolutional neural network. Alternatively, other configurations of a machine learning system 16 can be used, for example decision tree learning, support vector machines, regression analysis or Bayesian networks. Furthermore, it is possible to use a multi-task classification system. The multi-task classification system includes, for example, an encoder and a plurality of decoders. It is further possible to divide the machine learning system into multiple subsystems. Each of the subsystems has the functionality of the machine learning system 16 described here, although the subsystems do differ from one another, for example in the type of machine learning system or in the selection of the training data. Output data generated using the subsystems can then be combined in order to obtain an improved output.

Supervised learning is used to train the machine learning system. The machine learning system 16 is trained based on training data (input data X_1, X_2, . . . , X_n of the surroundings-capturing sensor 1 and corresponding nominal output data Y_1, Y_2, . . . , Y_n, which are determined by the reference sensor 5). By adjusting weights (or parameters) of the machine learning system 16, an error function is minimized, which indicates deviations between outputs Y′_1, Y′_2, . . . , Y′_n of the machine learning system for input data X_1, X_2, . . . , X_n from corresponding nominal output data Y_1, Y_2, . . . , Y_n.

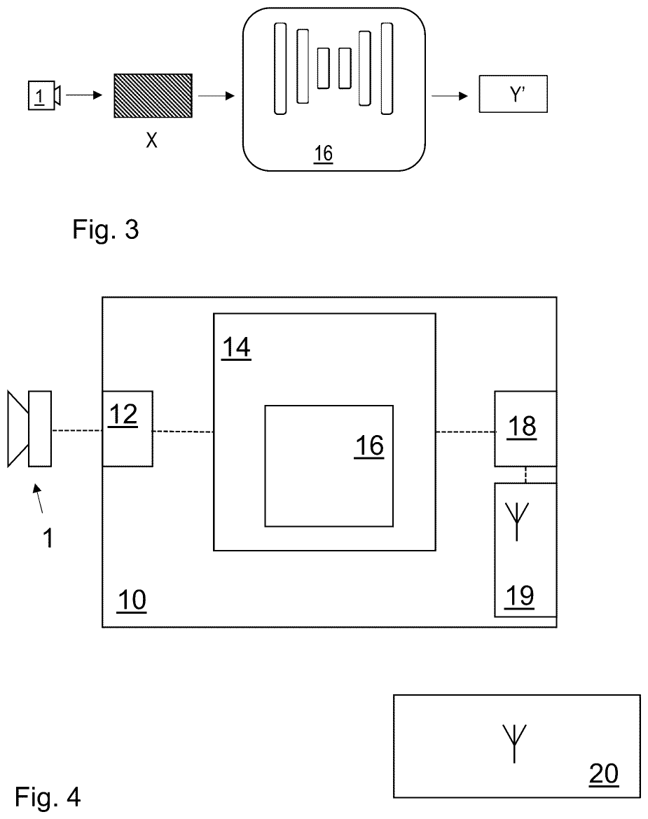

FIG. 3 shows a trained machine learning system 16 which can generate output data Y′, which characterize the road condition, based on (newly captured) data X from the surroundings-capturing sensor 1. The trained machine learning system 16 is utilized, for example, in a series vehicle.

FIG. 4 schematically shows an exemplary embodiment of a road condition monitoring system 10 which determines road condition data and can transfer these to a server unit 20. The road condition monitoring system 10 is electrically or wirelessly connected to at least one surroundings-capturing sensor 1, e.g., an image acquisition device, in a vehicle 2.

The data or signals captured by the surroundings-capturing sensor 1 are transferred to an input interface 12 of the road condition monitoring system 10. The data are processed in the road condition monitoring system 10 by a processing unit (or a data processor) 14. The processing unit 14 includes a machine learning system 16. The machine learning system 16 can include an artificial neural network, for example a CNN, which has been trained to classify the road condition. The classified road condition can be transmitted to further vehicle control units (e.g., an ADCU, automated driving control unit) via an output interface 18. A data transmission unit 19 serves to wirelessly transfer data and/or the classified road condition to a server unit 20 (cloud, backbone, infrastructure, etc.). To ensure that the artificial neural networks can process the data in the vehicle in real time, the road condition monitoring system 10 or the processing unit 14 can include one or more hardware accelerators for machine learning systems 16 or artificial neural networks.

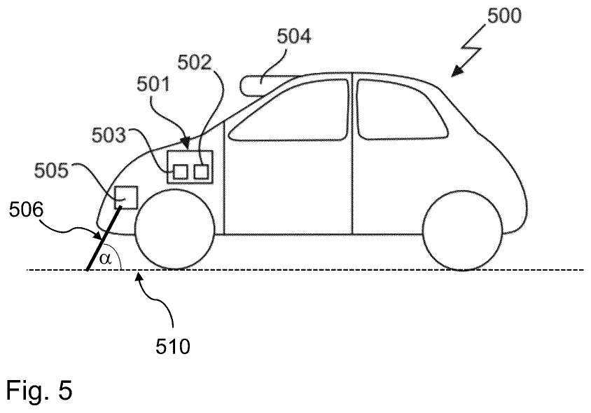

FIG. 5 shows a vehicle 500 having a reference sensor 505 with a transmitting and receiving unit. The vehicle has a sensor system 504, a road condition monitoring system 501 with a machine learning system 502 and a data transmission unit 503. The reference sensor 505 is arranged in the front of the vehicle, e.g., in front of the radiator, and has a beam direction 506 of the transmitting and receiving unit such that the angle α between the beam 506 and the road level is approximately 70°. The angle α can be set for specific vehicles 500, for example between 50° and 80°. The height of the beam 506 emerging from the reference sensor 505 above the road can be in the range of 20 to 60 centimeters.

In order to generate a first data set (seed phase), 500 test drives can be carried out with a vehicle 2 equipped with cameras, GPS and reference sensor. GPS is required in order to compare, e.g., with weather forecasts in the network.

In addition to the individual images (e.g., one image every second), the evaluation of the reference sensor is saved. If additional information is available-speed, acceleration, GPS, etc., then this will also be saved with the appropriate timestamp.

An additional human classification by a human can also be advantageous if an interesting situation arises. As a result, associated camera images and reference measurements can subsequently be found in the quantities of data. An additional feature of a reference sensor makes labeling via a CAN output possible on a feedback channel. Those situations, in which the human comes to a different conclusion from that of the reference sensor, are important.

For example, the additional information (“meta information”) can be saved in a separate classification file (txt, xml or json) which otherwise has the same name. A time reference should not be missing either, since some of the methods described subsequently require a time offset between images and reference measurement data, since the front camera sees, e.g., the piece of road earlier than the measurement spot of the reference measurement technology.

It is further noted that the camera images and classification files are named with a combination of the best preliminary classification, percentage, date, time, camera name, image angle and vehicle:

D_99_20210507_2023CET_front_90_F-TZ-333.jpg
D_99_20210507_2023CET_front_90_F-TZ-333.xml
(D_99_20210507_2023CET_front_90_F-TZ-333.txt)
(D_99_20210507_2023CET_front_90_F-TZ-333.json)
D = dry (W = wet, I = ice, S = snow, E = error)
99 = 99% for “dry”
20210507 = YYYYMMDD
2023CET = HHMM+time zone
front = front camera (left, right, back)
90 = 90° wide-angle
F-TZ-333 = license plate (optional)

Regarding the formats: txt is easy to read but difficult to parse, json is most easily machine-readable, but difficult to edit, and xml is a middle ground, which can still be edited by hand but is better machine-readable.

The intention of the preceding preliminary classification is to provide an ability to sort into classes by means of the name, and a very simple possible way of changing the label. This can occur in the active learning phase which is described subsequently. If the human overrules in that phase, the data can continue to be used, and the label can be adjusted. This is the only way to resolve contradictions in the data set.

The measurement data should be stored in subdirectories of the relevant day, since Linux systems run into problems as of 65,535 files per directory, without special modification of the typical variable sizes.

Another possible solution is a JSON database, e.g., MongoDB, for image and reference data instead of the easier-to-read image and text files.

Optionally, it should also be possible to transmit the GPS position of the vehicle in the data. License plates and GPS will be omitted later in the fleet test.

The GPS position can help to select sufficiently different locations, in particular in the seed phase, that is to say the initial phase of the network calculation, or if they are already the same locations, then only with different times of day and weather situations.

A specific example of the analysis of data from the reference sensor in the form of pseudocode:

% lrm=(r980m+r1310m+r1550m+r1552m+1)>>2; // overall brightness
% xrm=(((r1550m+r1552m)*1600)/r980m); // smaller: higher water
content
% yrm=((r980m*192)/r1310m); // larger: higher proportion of ice *or*
deeper water
% vrm=(r1550m*100/(r1550m+r1552m)); // inequality between the two
wavelengths 1550nm and 1552nm indicates contamination of the laser

In this case, r980 . . . r1552 are the intensities of the reflected light at the respective wavelength in nm, measured in ADU, that is to say units of the AD converter, xrm, yrm and vrm are ratiometric measurements (there is a denominator). The values xrm and yrm refer to different wavelengths, vrm to different channels of the same wavelength 1550 nm, and Irm is an absolute measurement, a brightness of the surface which is indicative of the difference between ice and snow.

% ice probability of pyrometer for early fusion
pp_ice=−40*TC_can+100; % 0% for Tc>2.5°c, 100% for Tc<0°C
if (pp_ice>99) pp_ice=99; end
if (pp_ice<0) pp_ice=0; end

The ice measurement with 1310 nm absorption is unreliable and is advantageously replaced by pyrometer measurement, the 1550 nm absorption occurs equally for water and ice, 1310 nm effects are only seen for ice, however they are significantly less distinct than water recognition with 1550 nm.

The pyrometer detects in the range 2 . . . 10 pm, thermal infrared, whereas 1550 nm is referred to as mid-IR.

% if(yrm>yr2) % Is ice present? Laser only!
if(pice>50) % Early fusion: Ice based on the pyrometer
psno=((lrm−lr1)*100)/(lr2−lr1); % Consider snow vs ice
pdry=0; % simplified!
pwet=0; % simplified!

Probabilities for dry, wet, ice, snow are determined directly from xrm (absorption of water at 1550 nm vs. 980 nm comparison), Tc (corrected road temperature from the pyrometer) and Irm (brightness of the surface) and, indeed one after the other, in a decision tree and in this order.

The foundations are the vibration modes of the water molecule and the radiation of black bodies, as well as the physics of direct and indirect semiconductors. A measurement at these wavelengths in IR is possible, but this is not possible with silicon because silicon becomes “transparent” as of 1000 nm, i.e., it is then no longer suitable as a photodiode. Germanium detects 1550 nm, but has a lot of signal noise if it is not cooled. InGaAs functions just as well as germanium for 1550 nm, but admittedly no cooling is needed. Surface coating improves quantum efficiency, however coating is a very costly technique.

For example, a complete data-driven ecosystem includes the following steps, which are run through cyclically:

Test data are continually collected using a fleet of test vehicles which have a telematics unit which can be updated by OTA (e.g., according to the 5G mobile communication standard). An ADCU uses a pre-trained machine learning system to continually establish AD or ADAS-relevant data from the collected sensor data (open loop testing) for the automated or assisted control of the vehicle. In the case of a trigger (e.g., anomalies, for example, the driver behaves differently to what the ADCU predicts), data are transmitted to the server unit/cloud. In the cloud, the data are checked to ascertain whether they are better training data than the data already present there. To this end, the predicted anomalies (or corner cases) can be verified or more relevant data can be selected for other reasons. The machine learning system or neural network can be retrained with the optimized training data using data aggregation (“you let the data decide”) or using active learning (wherein the human labeling effort is, however, reduced). Actual improvements are verified by an increase in KPIs (such as, e.g., precision and/or recall). The neural network is subsequently tested extensively in simulation worlds, test scenarios, corner cases or rare cases in order to increase the safety. If successful, the trained neural network is released and can be transferred with a cryptographic signature as an over-the-air update to the vehicles of the test fleet and installed as an update for the ADCU.

That is to say that circuit training in a data-driven ecosystem is necessary to achieve continual improvement. This does not simply increase the data set, but rather the relevance of the training data. Heavily underrepresented classes are transferred from images of the same situation to other locations by means of style transfer, so that the situation is not learned based on the location, but rather based on the appearance of the road. By shifting the time and projecting the path of the measurement site into the image, the measurement can be allocated to exactly one specific point on the road. Consequently, by bootstrapping, that is to say applying the same laws to all pixels which contain the road (wider network), the entire distribution on the road can be measured, predictively, therefore saving time, which benefits the necessary adjustments to driving behavior.

1. A method for training a machine learning system for monitoring the road condition, comprising:
providing or acquiring data by a sensor system of a vehicle, wherein the sensor system captures the surroundings of the vehicle as training input data;
providing or acquiring data which characterize a road condition of a road on which the vehicle is located by a reference sensor fitted in or on the vehicle as training target values; and
training the machine learning system;
wherein training data, which comprise training input data and training target values corresponding to these training input data, are provided, and
the training data are used to adjust parameters of the machine learning system in such a manner that the machine learning system generates output data similar to the training target values when the training input data are input.

2. The method according to claim 1, wherein the sensor system comprises a camera system of the vehicle so that the provided or acquired data are image data and the image data serve as training input data.

3. The method according to claim 1, wherein the reference sensor comprises a transmitting and receiving unit which emits electromagnetic radiation of at least one defined wavelength onto the road and receives and measures an intensity reflected by the road, and wherein the reference sensor is adapted to indicate probabilities for a presence of various classes of road conditions on the basis of the measured intensity.

4. The method according to claim 3, wherein the reference sensor outputs probabilities for the presence of the various road condition classes, comprising:
“dry,” “wet,” “snow,” “ice” and “unknown/error.”

5. The method according to claim 1, wherein the reference sensor comprises a pyrometer which measures a temperature of the road.

6. The method according to claim 3, wherein the reference sensor utilizes the following wavelengths:
1550 nm and 980 nm in order to detect a presence of water by a comparison of the reflected intensities, and
a wavelength in the range of 2 to 10 μm in order to measure a temperature of the road.

7. The method according to claim 1, wherein the machine learning system is a neural network.

8. The method according to claim 1, wherein the vehicle comprises a data transmission unit, and the data transmission unit is configured to transfer training data to a server unit.

9. The method according to claim 8, wherein the server unit is configured to update a training data set comprising a quantity of training data, wherein a size of the training data set is kept constant, and wherein based on one or more quality criteria, a relevance of the training data in terms of the road condition determination is increased when the training data set is updated.

10. The method according to claim 9, wherein the server unit is configured to attain a balance of the training data set during the updating, so that the training data set has a degree of diversity in which rarer road conditions are sufficiently represented by the training data.

11. The method according to claim 9, wherein the relevance of the training data is evaluated in such a manner that a degree of relevance is attributed to the training data which are orthogonal to the other training data already contained in the training data set.

12. The method according to claim 1, wherein the sensor data for the captured region of the road are divided into segments and the data provided or acquired by the reference sensor characterize the road condition for the segments.

13. A method for monitoring the road condition utilizing a machine learning system, wherein
the machine learning system is trained according to a method according to claim 1,
data captured by the vehicle sensor system, which captures the surroundings of the vehicle, are provided to the trained machine learning system as input data, and
the trained machine learning system generates output data which characterize the road condition from the input data.

14. A road condition monitoring system comprising
an input unit for receiving the input data;
a computer which is configured to carry out a method according to claim 13; and
an output interface coupled to the computer and which output the output data generated by the computer unit.

15. A vehicle comprising a sensor system, wherein the sensor system is configured to capture the surroundings of the vehicle and to provide the data from the sensor system to the input unit as the input data, and a road condition monitoring system according to claim 14.

16. The method according to claim 7, wherein the neural network comprises a convolutional neural network.
